(19) United States
(12) Patent Application Publication
(10) Pub. No.: US 2018/0263402 A1
(43) Pub. Date: Sep. 20, 2018

(54) ELECTRIC COOKER WITH FASTENING LOCK

(71) Applicant: Zhanjiang New Nanfang Electrical Appliance Co., Ltd., Zhanjiang (CN)

(72) Inventor: Weipeng LI, Zhanjiang (CN)

(21) Appl. No.: 15/869,543

(22) Filed: Jan. 12, 2018

(30) Foreign Application Priority Data
Mar. 20, 2017 (CN) 201720272807.X

(51) Int. Cl. A47J 27/08; A47J 27/086; A47J 36/10

(52) U.S. Cl. CPC A47J 27/0804; A47J 36/10; A47J 27/086

(57) ABSTRACT

The present invention discloses an electric cooker with fastening lock, comprising a heating base, a pot seated in the heating base and a lid for covering the pot, wherein handles are symmetrically arranged at opposite sides of outer wall of the heating base, and locking mechanisms, which can be locked to the handles by latches, are configured in both opposite edges on the upper surface of the lid; each locking mechanism comprises a locking base placed on the lid and a locking clip one end of which is hinged to the locking base, and each handle is provide with a locking hole for the insertion of another end of the locking clip and a pushing type switch for latching the another end of the lock clip when it was inserted in the locking hole.

### CROSS REFERENCE TO RELATED APPLICATION

This application claims priority of Application No. 201720272807.X filed in China on Mar. 20, 2017, under 35 U.S.C. §119, the entire contents of which are hereby incorporated by reference.

### FIELD OF TECHNOLOGY

The present invention relates to an electric cooker in the technical field of kitchen appliance, in particular, to an electric cooker with fastening lock.

### BACKGROUND

There are many kinds of kitchen appliances, among which cookers are a major type. Cooker can be classified into high-pressure cooker and low-pressure cooker according to their pressure state. For high-pressure cooker, its lid is generally sealed and fastened to the pot so as to form a high pressure state inside the pot. Currently there are various fastening mechanisms between the lid and the pot. However, such fastening mechanism or its operation is usually complicated, which restricts the further application of such cooker.

### SUMMARY

It is an object of the present invention to overcome the above drawbacks and provide an electric cooker with fastening lock. Such electric cooker adopts a novel fastening lock assembly which has a simple structure and is easy to be produced at a low cost. Besides, it can be operated conveniently and quickly and it is practical and reliable.

In order to achieve the above object, the present invention provides a technical solution as follows:

an electric cooker with fastening lock, comprising a heating base, a pot seated in the heating base and a lid for covering the pot, and handles are symmetrically arranged at opposite sides of outer wall of the heating base, wherein locking mechanisms, which can be locked to the handles by latches, are configured in both opposite edges on the upper surface of the lid; each locking mechanism comprises a locking base placed on the lid and a locking clip one end of which is hinged to the locking base, and each handle is provided with a locking hole for the insertion of another end of the lock clip and a pushing type switch for latching the another end of the lock clip when it is inserted in the locking hole.

Further, the locking clip is made of a metal wire and folded several times to form an L-shaped structure and an end of the locking clip, which is inserted into the locking hole is U-shaped.

Further, an elastic member is arranged in the middle of the locking base to facilitate the locking clip bouncing up and away from the handle when the locking clip is not latched.

Further, the pushing type switch comprises a pushing element located in the outside of the handle and a latch located inside the handle, wherein the pushing member and the latch form an integral structure.

Further, an elastic element, which is arranged inside the handle, is connected with the pushing type switch so as to ensure the latch tending towards a locked position always.

Compared with the prior art, the present invention has the following advantages.

The present invention adopts a novel fastening lock assembly, which has a simple structure and is easy to be produced at a low cost. Besides, it can be operated conveniently and quickly, and it is practical, safe and reliable.

### BRIEF DESCRIPTION OF THE DRAWINGS

A preferred embodiment will be described in detail hereinafter with reference to the following figures, wherein:

FIG. 1 is a structural schematic diagram showing the electric cooker in a locked state according to the embodiment of the present invention.

FIG. 2 is a structural schematic diagram showing separation state of the lid and the pot according to the embodiment of the present invention.

FIG. 3 is a structural schematic diagram showing how to unlock the locking clip according to the embodiment of the present invention.

### DETAILED DESCRIPTION OF THE PREFERRED EMBODIMENT

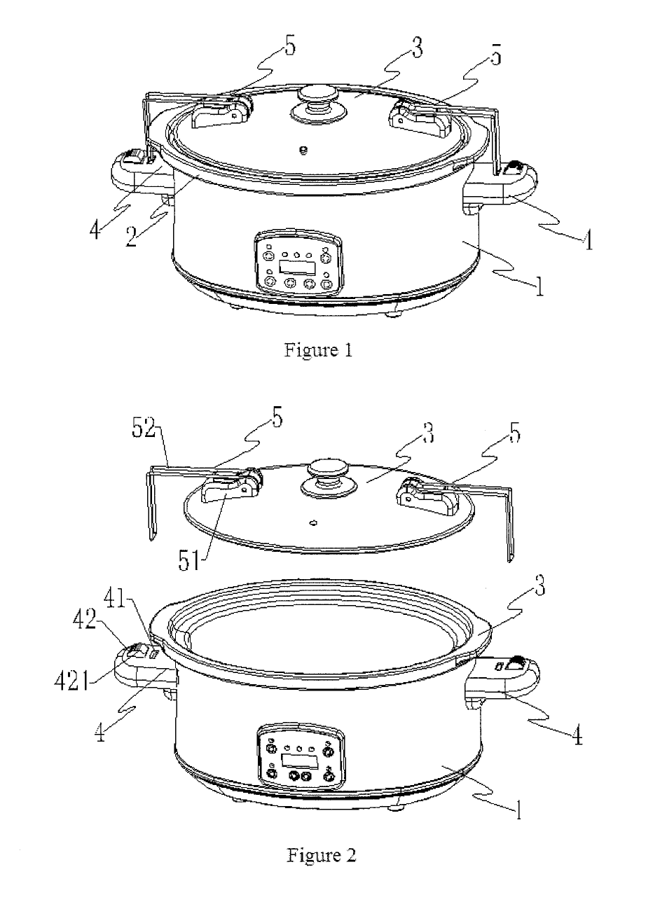

As shown in FIGS. 1 to 3, an electric cooker with fastening lock comprises a heating base 1, a pot 2 seated in the heating base, and a lid 3 for covering the pot, wherein handles 4 are symmetrically arranged at opposite sides of outer wall of the heating base 1, and two locking mechanisms 5, which can be locked to the handles by latches, are configured in both opposite edges on the upper surface of the lid 3.

The each locking mechanism 5 comprises a locking base 51 placed on the lid and a locking clip 52 one end of which is hinged to the locking base. The each handle 4 is provided with a locking hole 41 for the insertion of another end of the locking clip 52 and a pushing type switch 42 for latching the another end of the lock clip when it is inserted in the locking hole 41.

Further, the locking clip 52 is made of a metal wire and folded several times to form an L-shaped structure, and an end of the locking clip, which is inserted into the locking hole 41, is U-shaped. Moreover, an elastic member is arranged in the middle of the locking base 51 to facilitate the locking clip bouncing up and away from the handle when the locking clip is not latched.

Further, the pushing type switch 42 comprises a pushing member 421 located in the outside of the handle and a latch (not shown in the figures) located inside the handle, wherein the pushing member 421 and the latch form an integral structure.

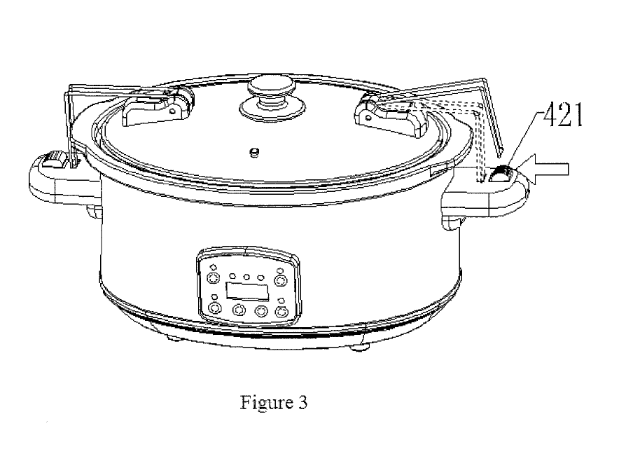

As a preferred embodiment, an elastic element (not shown in the figures), which is arranged inside the handle 4, is connected with the pushing type switch so as to ensure the latch tending towards the locking hole 41 always, i.e. a locked position. In such a structure, as the latch is in the locked position, when the lid and the pot need to be fastened together, the locking clip can be inserted into the locking hole such that the latch will be forced backwards first and then restore its locked position due to the elastic member, to lock the locking clip. When the lid and the pot need to be unlocked, the pushing member 421 can be slid in an opposite direction as shown in FIG. 3.

The embodiment described hereinbefore is merely preferred embodiment of the present invention and not for purposes of any restrictions or limitations on the invention. It will be apparent that any non-substantive, obvious alterations or improvement by the technician of this technical field according to the present invention may be incorporated into ambit of claims of the present invention.

What is claimed is:

1. An electric cooker with fastening lock, comprising a heating base, a pot seated in the heating base and a lid for covering the pot, and handles are symmetrically arranged at opposite sides of outer wall of the heating base,
wherein locking mechanisms, which can be locked to the handles by latches, are configured in both opposite edges on the upper surface of the lid, each locking mechanism comprises a locking base placed on the lid and a locking clip one end of which is hinged to the locking base, and each handle is provided with a locking hole for the insertion of another end of the locking clip and a pushing type switch for latching the another end of the lock clip when it is inserted in the locking hole.

2. The electric cooker of claim 1, wherein the locking clip is made of a metal wire and folded several times to form an L-shaped structure and an end of the locking clip, which is inserted into the locking hole, is U-shaped.

3. The electric cooker of claim 1, wherein an elastic member is arranged in the middle of the locking base to facilitate the locking clip bouncing up and away from the handle when the locking clip is not latched.

4. The electric cooker of claim 2, wherein an elastic member is arranged in the middle of the locking base to facilitate the locking clip bouncing up and away from the handle when the locking clip is not latched.

5. The electric cooker of claim 1, wherein the pushing type switch comprises a pushing member located in the outside of the handle and a latch located inside the handle, and the pushing member and the latch form an integral structure.

6. The electric cooker of claim 2, wherein the pushing type switch comprises a pushing member located in the outside of the handle and a latch located inside the handle, and the pushing member and the latch form an integral structure.

7. The electric cooker of claim 4, wherein an elastic element, which is arranged inside the handle, is connected with the pushing type switch so as to ensure the latch tending towards a locked position always.
